(19) United States
(12) Patent Application Publication
(10) Pub. No.: US 2016/0125902 A1
(43) Pub. Date: May 5, 2016

(54) MAGNETIC DISK DEVICE AND CONTROL METHOD

(71) Applicant: Kabushiki Kaisha Toshiba, Tokyo (JP)

(72) Inventor: Masafumi Iwashiro, Yokohama Kanagawa (JP)

(21) Appl. No.: 14/637,008

(22) Filed: Mar. 3, 2015

Related U.S. Application Data
(60) Provisional application No. 62/075,504, filed on Nov. 5, 2014.

(51) Int. Cl. G11B 5/55

(52) U.S. Cl. CPC G11B 5/5565; G11B 5/5547

(57) ABSTRACT

According to one embodiment, there is provided a magnetic disk device including a casing, a seek mechanism, and a controller. The seek mechanism is attached to the casing and configured to make a magnetic head seek a target track on a magnetic disk. The controller is configured to feedback-control the seek mechanism so as to reduce a reaction force acting on the casing during an acceleration period of seek by the seek mechanism.

### CROSS-REFERENCE TO RELATED APPLICATIONS

This application is based upon and claims the benefit of priority from U.S. Provisional Application No. 62/075,504, filed on Nov. 5, 2014; the entire contents of which are incorporated herein by reference.

### FIELD

Embodiments described herein relate generally to a magnetic disk device and control method.

### BACKGROUND

In magnetic disk device, a seek mechanism attached to a casing makes a magnetic head seek a target position (target track) on a magnetic disk. At this time, receiving a seek reaction force from the seek mechanism, the casing may vibrate.

### BRIEF DESCRIPTION OF THE DRAWINGS

FIG. 1 is a block diagram showing the configuration of a magnetic disk device according to a first embodiment;

FIGS. 2A to 2D are waveform diagrams showing a seek operation in the first embodiment;

FIG. 3 is a block diagram showing configuration of a rotation vibration controller in the first embodiment;

FIGS. 4A to 4D are waveform diagrams showing feedback-control in the first embodiment;

FIGS. 5A and 5B are waveform diagrams showing the feedback-control in the first embodiment;

FIG. 6 is a flow chart showing operation of the magnetic disk device according to the first embodiment;

FIG. 7 is a flow chart showing a calibration process in the first embodiment;

FIG. 8 is a flow chart showing a calibration process in a second embodiment;

FIG. 9 is a block diagram showing configuration of a magnetic disk device according to a third embodiment; and

FIG. 10 is a block diagram showing configuration of a rotation vibration controller for seek and a rotation vibration controller for tracking in the third embodiment.

### DETAILED DESCRIPTION

In general, according to one embodiment, there is provided a magnetic disk device including a casing, a seek mechanism, and a controller. The seek mechanism is attached to the casing and configured to make a magnetic head seek a target track on a magnetic disk. The controller is configured to feedback-control the seek mechanism so as to reduce a reaction force acting on the casing during an acceleration period of seek by the seek mechanism.

Exemplary embodiments of a magnetic disk device will be explained below in detail with reference to the accompanying drawings. The present invention is not limited to the following embodiments.

### First Embodiment

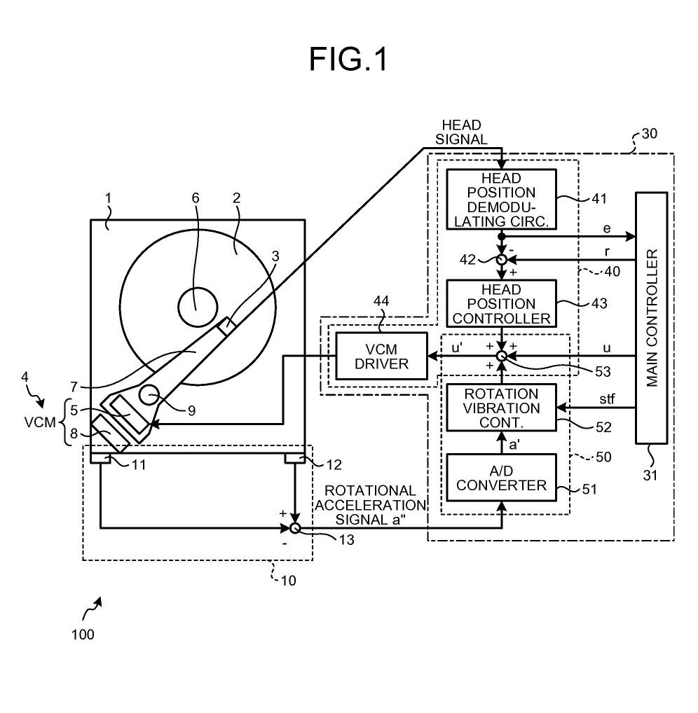

The external appearance configuration of a magnetic disk device 100 according to the first embodiment will be described using FIG. 1. FIG. 1 is a block diagram showing the configuration of the magnetic disk device 100.

The magnetic disk device 100 comprises a casing 1, a magnetic disk 2, a magnetic head 3, an actuator (seek mechanism) 4, a spindle motor 6, an arm 7, a controller 30, and a detecting unit 10. The controller 30 has a position controller 40, a correcting unit 50, and a main controller 31.

The magnetic disk 2 is mounted to be rotatable via the spindle motor 6 in the casing 1. The magnetic disk 2 is a disc-shaped recording medium to record a variety of information and is rotationally driven by the spindle motor 6. The magnetic disk 2 has a substantially perpendicular recording layer anisotropic in a direction perpendicular to the surface.

Further, the magnetic head 3 and the arm 7 are mounted to be rotationally drivable around a pivot 9 via the actuator 4 in the casing 1. Reading from and writing onto the magnetic disk 2 are performed by the magnetic head 3 provided on one end of the arm 7 that is a head support mechanism. The magnetic head 3 records information onto the magnetic disk 2 or reads information recorded on the magnetic disk 2 with keeping in the state of being lifted slightly from the surface of the magnetic disk 2 by lift force generated by the rotation of the magnetic disk 2. The arm 7 is rotationally moved on an arc with the pivot 9 as the center by the driving of the actuator 4 and makes the magnetic head 3 seek in a cross-track direction of the magnetic disk 2 so as to change tracks to be read from or written onto.

At this time, the magnetic head 3 reads servo information provided periodically along a direction in which the magnetic disk 2 rotates on the surface of the magnetic disk 2 and outputs the read servo information (a head signal) to the position controller 40. The position controller 40 controls the actuator 4 according to the servo information (head signal) so as to position the magnetic head 3 with respect to the magnetic disk 2. The actuator 4 includes a voice coil motor VCM. The voice coil motor VCM includes a magnet 8 and a voice coil 5. The magnet 8 is secured to the casing 1. The actuator 4 makes the magnetic head 3 seek via the arm 7 using a force electromagnetically exerted from the magnet 8 onto the voice coil 5.

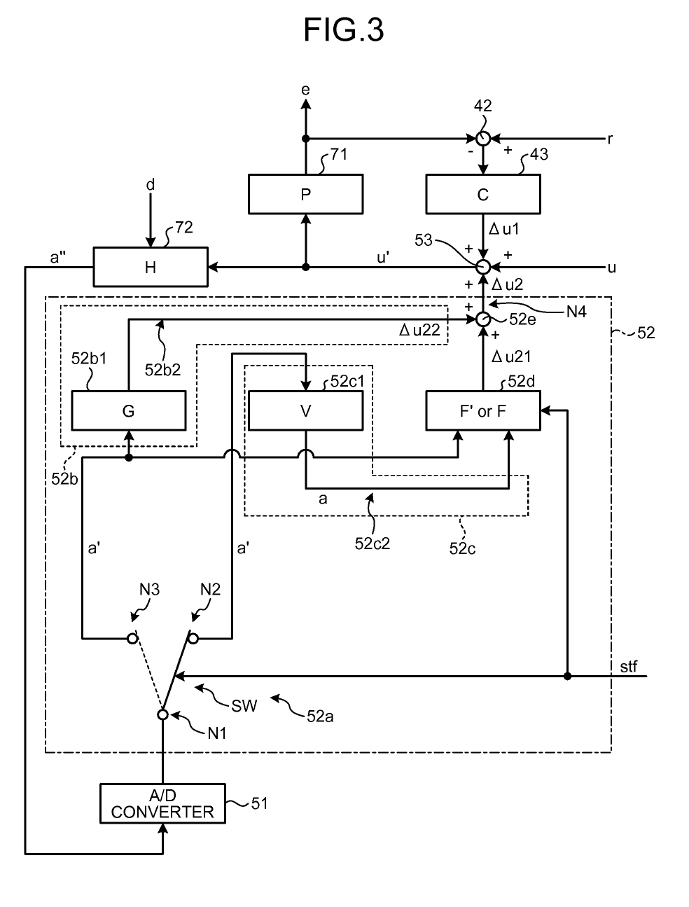

For example, the position controller 40 has a head position demodulating circuit 41, a subtracter 42, a head position controller 43, an adder 53, and a VCM driver 44. The head position demodulating circuit 41 demodulates a head position signal indicating the position of the magnetic head 3 from the head signal to supply to the subtracter 42. The subtracter 42 receives a target position signal r from the main controller 31 to subtract the head position signal from the target position signal r and to supply the subtracting result as a position deviation to the head position controller 43. The head position controller 43 obtains such a correction amount for the VCM operation amount of the actuator 4 that the position deviation approaches zero and supplies to the adder 53. The adder 53 receives the VCM operation amount u from the main controller 31 and adds a correction amount Δu1 and the like (see FIG. 3) to the VCM operation amount u to supply the adding result as a VCM control signal u′ to the VCM driver 44. The VCM driver 44 controls the rotational movement of the actuator 4 according to the VCM control signal u′ so as to make the magnetic head 3 seek.

A fan and another magnetic disk device not shown are placed near the magnetic disk device 100. The fan and other magnetic disk device, as being driven, may exert a rotation-vibration-exciting force on the casing 1 of the magnetic disk device 100. The casing 1 receiving the rotation-vibration-exciting force rotationally vibrates. Such rotation vibration of the casing 1 directly affects the rotational movement of the arm 7 around the pivot 9 to cause relative position displacement between the magnetic disk 2 and the magnetic head 3. When the position displacement is caused, the accuracy in positioning by the position controller 40 decreases, so that it may be difficult to correctly record or read data by the magnetic head 3. In order to suppress this position displacement, the detecting unit 10 detects rotational acceleration acting on the casing 1 during the tracking period while the correcting unit 50 obtains a vibration correction amount to correct for the rotation vibration of the casing 1 with based on the rotational acceleration acting on the casing 1. That is, the correcting unit 50 feed-forward controls the actuator 4 based on the rotation vibration of the casing 1 during the tracking period.

For example, the detecting unit 10 has a plurality of translational acceleration sensors 11, 12 and a difference unit 13. The plurality of translational acceleration sensors 11, 12 are fixed to different places of the casing 1. The plurality of translational acceleration sensors 11, 12 are placed, for example, on opposite sides of the magnet 8. The plurality of translational acceleration sensors 11, 12 each detect the acceleration acting on the casing 1 to supply the detecting result as an acceleration signal to the difference unit 13. The difference unit 13 takes the difference between the acceleration signals received from the translational acceleration sensors 11, 12. That is, the difference unit 13 generates the difference between the accelerations detected by the translational acceleration sensors 11, 12 as a rotational acceleration signal indicating the rotational acceleration acting on the casing 1. The difference unit 13 supplies the generated rotational acceleration signal to the correcting unit 50. The correcting unit 50 has an A/D converter 51, a rotation vibration controller 52, and an adder 53. The A/D converter 51 A/D converts the rotational acceleration signal (an analog signal) to generate a rotational acceleration signal (digital signal) so as to supply to the rotation vibration controller 52. The rotation vibration controller 52 obtains a correction amount based on the rotation vibration indicated by the rotational acceleration signal during the tracking period to supply to the adder 53.

That is, letting Δu1 be the correction amount generated by the head position controller 43 and Δu2 be the correction amount generated by the rotation vibration controller 52, the adder 53 obtains a VCM control signal u′ from the following formula 1 to supply to the VCM driver 44. The VCM driver 44 drives the actuator 4 according to the VCM control signal u′.

u′=u+Δu1+Δu2 formula 1

Thus, the controller 30 feedback-controls the actuator 4 so that the magnetic head 3 is located at the target position during the tracking period and simultaneously feed-forward controls the actuator 4 so that rotation vibration is suppressed. The adder 53 is shared by the position controller 40 and the correcting unit 50.

During the seek period, an electromagnetic force is exerted from the magnet 8 onto the voice coil 5 of the actuator 4 so as to make the magnetic head 3 seek the target track on the magnetic disk 2 by means of the arm 7. At this time, the magnet 8 receives a seek reaction force as reaction from the voice coil 5. Since the magnet 8 is attached to the casing 1, the seek reaction force received by the magnet 8 is transmitted to the casing 1, so that the casing 1 may vibrate.

One tends to think that, because neither recording nor reproducing data is performed during the seek period, the necessity of suppressing vibration is low. However, as mentioned above, another magnetic disk device is placed near the magnetic disk device 100. For example, the magnetic disk device 100 and the other magnetic disk device may be both attached to the housing of a server. While the magnetic disk device 100 is in seek operation, the other magnetic disk device may be in tracking operation. In this case, the vibration of the casing due to the seek reaction force of the magnetic disk device 100 is likely to be transmitted to the casing of the other magnetic disk device via the housing. Thus, in the other magnetic disk device, relative position displacement between the magnetic disk 2 and the magnetic head 3 in tracking may be caused. In the other magnetic disk device, with position displacement being caused, the accuracy in positioning by the position controller 40 decreases, so that it may be difficult to correctly record or read data by the magnetic head 3. That is, even during the seek period, in order to reduce the vibration of the other magnetic disk device excited by it, the vibration of the casing 1 of the magnetic disk device 100 needs to be suppressed.

Accordingly, in the present embodiment, the magnetic disk device 100 detects the seek reaction force acting on the casing 1 during the seek period and feedback-controls the actuator 4 in such a way as to reduce the detected seek reaction force, thereby suppressing the vibration of the casing 1 due to the seek reaction force.

Specifically, the detecting unit 10 detects the rotational acceleration acting on the casing 1 in association with the seek operation by the actuator 4 during the seek period. For example, in the detecting unit 10, the plurality of translational acceleration sensors 11, 12 each detect the acceleration acting on the casing 1 to supply the detecting result as an acceleration signal to the difference unit 13. The difference unit 13 generates the difference between the accelerations detected by the translational acceleration sensors 11, 12 as a rotational acceleration signal indicating the rotational acceleration acting on the casing 1. The difference unit 13 supplies the rotational acceleration signal a″ to the correcting unit 50.

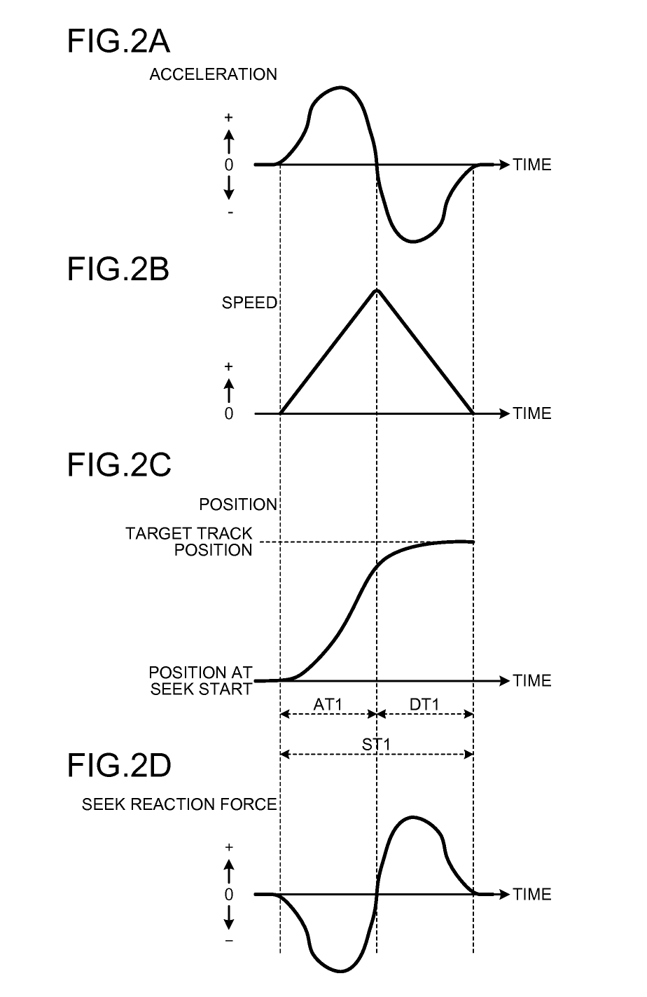

FIG. 2A shows acceleration that the actuator 4 causes to act on the arm 7 during the seek operation. FIG. 2B shows change in the rotation speed of the arm 7 (the magnetic head 3) due to the seek of the actuator 4. FIG. 2C shows change in the rotation position of the arm 7 (the magnetic head 3) due to the seek of the actuator 4. During the seek period, the rotational acceleration signal includes a component denoting the rotation vibration excitation for the casing 1 and a component denoting the seek reaction force. For example, the actuator 4 makes the magnetic head 3 accelerate via the arm 7 in the seek-operation direction to seek during the seek acceleration period AT1 as shown in FIG. 2A. At this time, the rotation speed of the arm 7 (the magnetic head 3), in the seek-operation direction (on the plus side), gradually increases as shown in FIG. 2B, and the rotation position of the arm 7 (the magnetic head 3) changes from the position at the time of seek start to a position near the target track as shown in FIG. 2C. The component denoting the seek reaction force is in a rotational direction opposite to that of the rotational acceleration (see FIG. 2A) of the arm 7. That is, the component denoting the seek reaction force is in a rotational direction (on the minus side) opposite to the direction in which the actuator 4 performs seek operation with the pivot 9 as the center during the acceleration period AT1 of seek by the actuator 4 as shown in FIG. 2D.

Further, the actuator 4 makes the magnetic head 3 accelerate via the arm 7 in a rotational direction (on the minus side) opposite to the seek-operation direction (i.e., decelerate) to seek during the seek deceleration period DT1 as shown in FIG. 2A. At this time, the rotation speed of the arm 7 (the magnetic head 3), in the seek-operation direction, gradually decreases as shown in FIG. 2B, and the rotation position of the arm 7 (the magnetic head 3) changes from the position near the target track to the position of the target track as shown in FIG. 2C. The component denoting the seek reaction force is in a rotational direction opposite to that of the rotational acceleration of the arm 7. That is, the component denoting the seek reaction force is in the direction (on the plus side) in which the actuator 4 performs seek operation with the pivot 9 as the center during the deceleration period DT1 of seek by the actuator 4 as shown in FIG. 2D. Although FIGS. 2A to 2D illustrate the case where the seek period includes the deceleration period DT1 following the acceleration period AT1, the seek period may include a constant-speed period during which the speed is substantially constant between the acceleration period AT1 and the deceleration period DT1.

To what degree the rotational acceleration signal includes the component denoting the seek reaction force can change depending on the usage environment for the magnetic disk device 100 (such as the rigidity of the casing 1, the fixed state of the casing 1, and the rigidity of the housing to which the casing 1 is attached).

The correcting unit 50 obtains a correction amount with which to feedback-control the actuator 4 so as to reduce the seek reaction force agreeing with the rotational acceleration detected by the detecting unit 10 during the seek period. The correcting unit 50 obtains the seek reaction force acting on the casing 1 based on the rotational acceleration signal and obtains a correction amount for the operation amount of the actuator 4 so as to reduce the obtained seek reaction force. The correcting unit 50 obtains the correction amount for the operation amount of the actuator 4 so that, for example, the difference between the obtained seek reaction force and the target seek reaction force approaches zero.

For example, in the correcting unit 50, the A/D converter 51 A/D converts the rotational acceleration signal (an analog signal) a″ to generate a rotational acceleration signal (digital signal) a′ so as to supply the rotational acceleration signal (digital signal) a′ to the rotation vibration controller 52. The rotation vibration controller 52 obtains a seek reaction force a from the rotational acceleration signal a′ during the seek period and obtains a correction amount to reduce the obtained seek reaction force a to supply to the adder 53.

That is, letting Δu1 (see FIG. 3) be the correction amount generated by the head position controller 43 and Δu2 (see FIG. 3) be the correction amount generated by the rotation vibration controller 52, the adder 53 obtains the VCM control signal u′ from the aforementioned formula 1 to supply to the VCM driver 44. The VCM driver 44 drives the actuator 4 according to the VCM control signal u′. Thus, the controller 30 feedback-controls the actuator 4 so that the magnetic head 3 arrives at the target position during the seek period and simultaneously feedback-controls the actuator 4 so as to reduce the seek reaction force.

That is, the controller 30 feedback-controls the actuator 4 so as to reduce the seek reaction force during the seek period and feed-forward controls the actuator 4 so as to suppress rotation vibration during the tracking period. The controller 30 is configured to be able to switch between a feedback-control configuration and a feed-forward control configuration. For example, the rotation vibration controller 52 receives a seek/tracking determination flag stf from the main controller 31. The main controller 31 determines whether the present is in the seek period or in the tracking period according to the situation of the control under way. Or the main controller 31 may exactly determine seek/tracking from information about position e during seek. The main controller 31 determines the value of the seek/tracking determination flag stf according to the result of the determination to supply to the rotation vibration controller 52. If the determination flag stf is at a value indicating the seek period (e.g., 1), the rotation vibration controller 52 switches its configuration to the feedback-control configuration. If the determination flag stf is at a value indicating the tracking period (e.g., 0), the rotation vibration controller 52 switches its configuration to the feed-forward control configuration.

More specifically, the rotation vibration controller 52 has a feed-forward unit 52b, a feedback unit 52c, a filter 52d, an adder 52e, and a switching unit 52a as shown in FIG. 3.

FIG. 3 is a block diagram showing mainly the configuration of the rotation vibration controller 52. A plant 71 models the transfer characteristic P of ‘the VCM driver 44->the actuator 4->the arm 7->the magnetic head 3->the head position demodulating circuit 41’. The head position e output from the plant 71 is subtracted from the target position signal r in the subtracter 42, and the subtracting result is input as a position deviation to the head position controller 43. The head position controller 43 has a filter coefficient agreeing with a control characteristic C and multiplies the position deviation by the filter coefficient so as to obtain the correction amount Δu1 to supply to the adder 53. A vibration system 72 models the transfer characteristic H of ‘the VCM driver 44->the actuator 4->the casing 1->the detecting unit 10’. The vibration system 72 may receive rotation-vibration-exciting disturbance d from the outside. The rotational acceleration signal (an analog signal) a″ output from the vibration system 72 is A/D converted by the A/D converter 51 into the rotational acceleration signal (digital signal) a′ to be input to the rotation vibration controller 52.

During the seek period, the switching unit 52a of the rotation vibration controller 52 enables the feedback unit 52c and the filter 52d while disabling the feed-forward unit 52b. During the tracking period, the switching unit 52a enables the feed-forward unit 52b and the filter 52d while disabling the feedback unit 52c. Thus, the switching unit 52a switches the configuration of the rotation vibration controller 52 to the feedback-control configuration during the seek period and to the feed-forward control configuration during the tracking period.

For example, the switching unit 52a has an input node N1, connection nodes N2, N3, and a switch SW. The input node N1 receives the rotational acceleration signal (digital signal) a′ from the A/D converter 51. The connection node N2 is connected to the input side of the feedback unit 52c. The connection node N3 is connected to the input side of the feed-forward unit 52b and to the input of the filter 52d. The switch SW switches between the state of the input node N1 being connected to the connection node N2 (the state indicated by a solid line in FIG. 3) and the state of the input node N1 being connected to the connection node N3 (the state indicated by a broken line in FIG. 3) according to the value of the determination flag stf.

The feed-forward unit 52b is enabled during the tracking period and disabled during the seek period. The feed-forward unit 52b obtains a correction amount Δu22 agreeing with the rotational acceleration detected by the detecting unit 10 during the tracking period to supply to the output side (adder 52e) of the filter 52d. The feed-forward unit 52b has a filter 52b1 and a line 52b2. The filter 52b1 has a filter coefficient agreeing with a transfer characteristic G. The transfer characteristic G is a mechanical transfer characteristic of from the rotational acceleration signal a′ to the VCM operation amount u, but can be approximately regarded as a mechanical transfer characteristic of from the rotation-vibration-exciting disturbance d to the VCM operation amount u. The filter 52b1 has its input side connected to the connection node N3 and its output side connected to the adder 52e via the line 52b2. The filter 52b1 multiplies the rotational acceleration signal a′ by the filter coefficient so as to obtain the correction amount Δu22 to supply the obtained correction amount Δu22 to the adder 52e via the line 52b2 during the tracking period.

The feedback unit 52c is enabled during the seek period and disabled during the tracking period. The feedback unit 52c obtains the seek reaction force agreeing with the rotational acceleration detected by the detecting unit 10 during the seek period to supply to the input side of the filter 52d. The feedback unit 52c has a filter 52c1 and a line 52c2. The filter 52c1 has a filter coefficient agreeing with a transfer characteristic V. The transfer characteristic V is a transfer characteristic of from the rotational acceleration signal a′ to the seek reaction force a and can change depending on the usage environment for the magnetic disk device 100 (such as the rigidity of the casing 1, the fixed state of the casing 1, and the rigidity of the housing to which the casing 1 is attached). The transfer characteristic V is obtained by a calibration process described later. The filter 52c1 has its input side connected to the connection node N2 and its output side connected to the filter 52d via the line 52c2. The filter 52c1 multiplies the rotational acceleration signal a′ by the filter coefficient so as to obtain the seek reaction force a to supply the obtained seek reaction force a to the filter 52d via the line 52c2 during the seek period.

The filter 52d is enabled during both the tracking period and the seek period. The filter 52d has its input side connected to the connection node N3 and to the output side of the feedback unit 52c and its output side connected to the adder 52e. The filter 52d has the filter coefficient for feed-forward control (a filter characteristic F′) and the filter coefficient for feedback-control (a filter characteristic F). The filter 52d receives the seek/tracking determination flag stf from the main controller 31 and switches between the filter coefficient for feedback-control and the filter coefficient for feed-forward control according to the determination flag stf.

During the tracking period, the filter 52d obtains a correction amount Δu21 agreeing with the rotational acceleration detected by the detecting unit 10 to supply to the adder 52e. For example, if the determination flag stf is at a value indicating the tracking period (e.g., 0), the filter 52d switches the filter coefficient to multiply its input by to the filter coefficient for feed-forward control. The filter 52d receives the rotational acceleration signal a′ from the node N3 during the tracking period and multiplies the rotational acceleration signal a′ by the filter coefficient for feed-forward control so as to obtain the correction amount Δu21 to supply to the adder 52e.

During the seek period, the filter 52d obtains the correction amount Δu21 to reduce the seek reaction force a obtained by the feedback unit 52c so as to supply to the adder 52e. For example, if the determination flag stf is at a value indicating the seek period (e.g., 1), the filter 52d switches the filter coefficient to multiply its input by to the filter coefficient for feedback-control. The filter 52d receives the seek reaction force a from the feedback unit 52c during the seek period and multiplies the seek reaction force a by the filter coefficient for feedback-control so as to obtain the correction amount Δu21. That is, the filter 52d obtains the correction amount Δu21 for the operation amount of the actuator 4 so that the difference between the seek reaction force a and the target seek reaction force approaches zero. The filter 52d supplies the obtained correction amount Δu21 to the adder 52e.

During the tracking period, the adder 52e adds the correction amount Δu22 output from the feed-forward unit 52b and the correction amount Δu21 output from the filter 52d and supplies the adding result as the correction amount Δu2 (=Δu21+Δu22) to the adder 53. During the seek period, the adder 52e supplies the correction amount Δu21 output from the filter 52d, as it is, as the correction amount Δu2 (=Δu21) to the adder 53.

In the rotation vibration controller 52, if the determination flag stf is at a value indicating the tracking period (e.g., 0), the switch SW switches the input node N1 to the state of being connected to the connection node N3. Thus, during the tracking period, each of the path from the input node N1 via the filter 52d to the output node N4 and the path from the input node N1 via the feed-forward unit 52b to the output node N4 can be enabled. That is, the rotation vibration controller 52 can be switched to the feed-forward control configuration.

In the rotation vibration controller 52, during the tracking period, the filter 52d agreeing with the filter characteristic F′, which calculates a VCM correction value based on rotation vibration excitation, is disposed in parallel with the filter 52b1 agreeing with the transfer characteristic G. Accordingly, the adder 53 adds a VCM correction value Δu1 based on a head position error, a VCM correction value Δu2 based on rotation vibration excitation, and the VCM operation amount u so as to produce the VCM control signal u′ (see formula 1). Because the transfer characteristic G and the filter characteristic F′ in parallel produce the VCM control signal u′ to be applied to the plant (P) 71 from the rotation-vibration-exciting disturbance d (≈ the rotational acceleration signal a′), the filter characteristic F′ suitable to cancel out the disturbance having gone through the transfer characteristic G is given by the formula 2 below. For example, the filter characteristic F′ of the filter 52d can be implemented by a filter of a finite degree to be a characteristic as close to the transfer characteristic G as possible.

F′≈−G formula 2

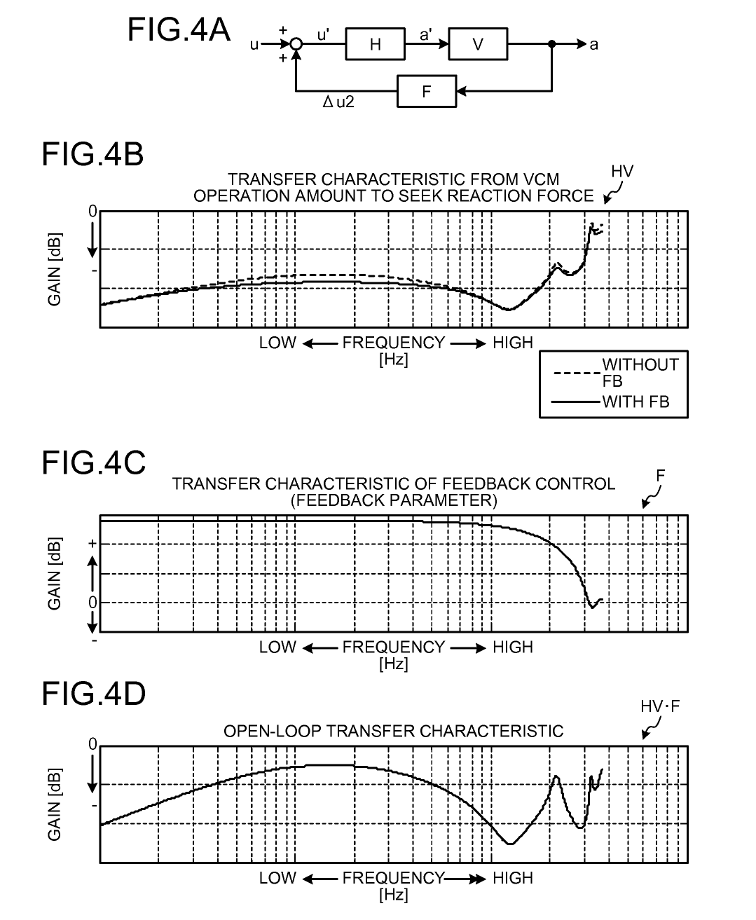

In contrast, for the self-vibration of the casing 1 by the seek reaction force, there are a transfer characteristic HV (=H·V) of from the VCM operation amount u to the seek reaction force a, a transfer characteristic 1/V of from the seek reaction force a to the rotational acceleration signal a′, and the filter characteristic F of from the seek reaction force a to a VCM operation amount increment. Hence, their transfer characteristics together form a closed loop of H to V to F to H as shown in FIG. 4A. FIG. 4A shows the configuration of the closed loop when the seek reaction force a is generated according to the VCM operation amount u. FIG. 4B shows the transfer characteristic HV of from the VCM operation amount u to the seek reaction force a. FIG. 4C shows the filter characteristic F of the filter 52d that is the transfer characteristic of feedback-control (a feedback parameter). FIG. 4D shows an open-loop transfer characteristic HVF (=HV·F) in the closed loop of ‘H->V->F->H’. In FIGS. 4B to 4D, the vertical axis represents the magnitude of gain (dB), and the horizontal axis represents the magnitude of frequency (Hz) in logarithmic format. The gain of the transfer characteristic HV can be suppressed more when the feedback-control of the seek reaction force a by the closed loop system is performed (as indicated by a solid line in FIG. 4B) than when feed-forward control is performed (as indicated by a broken line in FIG. 4B). Accordingly, the configuration is made not for the feed-forward control of the rotational acceleration signal a′ but for the feedback-control of the seek reaction force a so as to aim to reduce the seek reaction force a and also improve the stability of the closed loop system.

Hence, in the rotation vibration controller 52, if the determination flag stf is at a value indicating the seek period (e.g., 1), the switch SW switches the input node N1 to the state of being connected to the connection node N2. Thus, during the seek period, the path from the input node N1 via the feedback unit 52c and the filter 52d to the output node N4 can be enabled, and the rotation vibration controller 52 can be switched to the feedback-control configuration.

For example, the rotational acceleration occurring in the casing 1 due to the seek reaction force is measured as the difference between the observed values of the two translational acceleration sensors 11, 12. The rotational acceleration signal a″ is read into the circuit by the A/D converter 51 and goes through the rotation vibration controller 52 to produce the correction value Δu2. The output Δu1 of the head position controller 43 and the VCM operation amount u are added to the output Δu2 of the rotation vibration controller 52 to produce the VCM control signal u′ to be applied to the VCM driver (see formula 1). The VCM control signal u′ applied to the VCM driver 44 drives the VCM 5, so that the seek reaction force is generated while the magnetic head 3 is moving on the magnetic disk 2. Accordingly, the feedback-control according to the VCM operation amount u is performed to suppress the seek reaction force, but if the feedback gain is large, the correction amount is also large, so that the feedback-control system may oscillate or that the performance of the feedback-control may degrade.

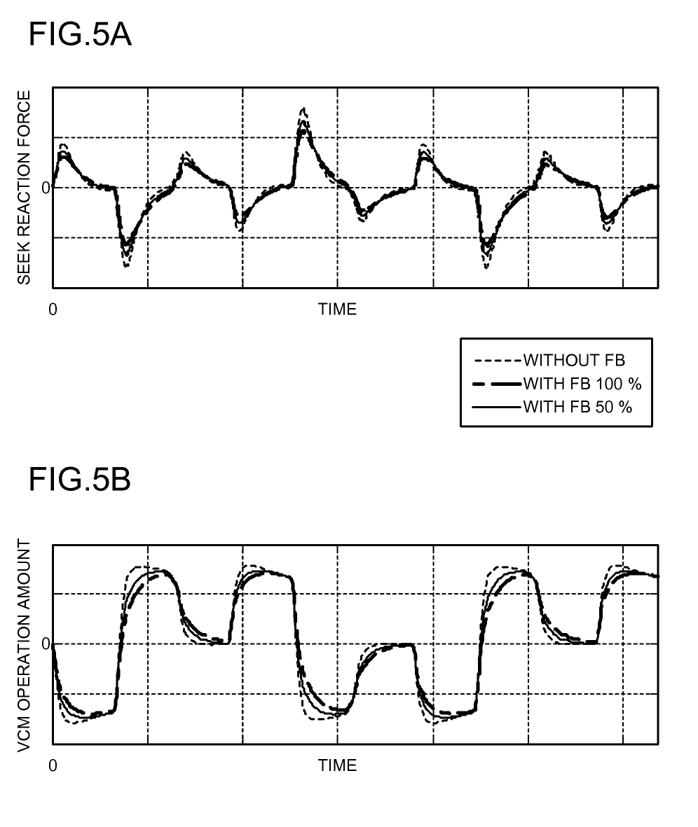

Consider, for example, the case where such feedback-control is performed that the seek reaction force a is suppressed with a feedback gain of 100% with respect to a deviation from the target seek reaction force. In this case, as indicated by a dot-dashed line in FIG. 5A, the seek reaction force can be greatly reduced as compared with the case of not performing feedback-control (as indicated by a broken line in FIG. 5A). However, the waveform of the VCM operation amount deteriorates in shape, as indicated by a dot-dashed line in FIG. 5B, compared with the case of not performing feedback-control (as indicated by a broken line in FIG. 5B). Thus, the VCM operation characteristic, that is, the performance of the actuator 4 degrades. As opposed to this, consider the case where such feedback-control is performed that the seek reaction force a is suppressed with a feedback gain of 50% with respect to a deviation from the target seek reaction force. In this case, as indicated by a solid line in FIG. 5A, the seek reaction force can be reduced as compared with the case of not performing feedback-control (as indicated by the broken line in FIG. 5A). Further, the risings in the waveform of the VCM operation amount can be made steep, as indicated by a solid line in FIG. 5B, compared with the case of the feedback gain of 100% (as indicated by the dot-dashed line in FIG. 5B). Therefore, the degradation in the VCM operation characteristic, that is, the performance of the actuator 4 can be suppressed.

That is, in order to suppress the degradation in the performance of the actuator 4, the filter characteristic F (a feedback parameter) of the filter 52d needs to be designed such that the feedback gain takes on an appropriate value (e.g., a feedback gain of 50%).

The difference between the configuration of the feedback unit 52c shown in FIG. 3 and that of the feed-forward unit 52b is that the filter 52c1 of the transfer characteristic V connected to the input side of the filter 52d exists instead of the filter 52b1 of the transfer characteristic G connected to the output side of the filter 52d. The feed-forward is performed with the filter 52b1 of the transfer characteristic G, whereas the feedback is performed with the filter 52c1 of the transfer characteristic V. The gain peak value of the open-loop transfer characteristic HVF being smaller than 1 (i.e., smaller than 0 dB) is a condition for the stability of the feedback-control system, and the gain of the transfer characteristic HV can change depending on the usage environment for the magnetic disk device 100 (such as the rigidity of the casing 1, the fixed state of the casing 1, and the rigidity of the housing to which the casing 1 is attached). The gain peak value of the open-loop transfer characteristic HVF also needs to be made to have a margin to a stability limit taking into account the usage environment for the magnetic disk device 100. Therefore, in order to make the feedback-control system stably operate, the filter characteristic F (a feedback parameter) of the filter 52d needs to be designed such that the gain peak value of the open-loop transfer characteristic HVF has a margin to a stability limit.

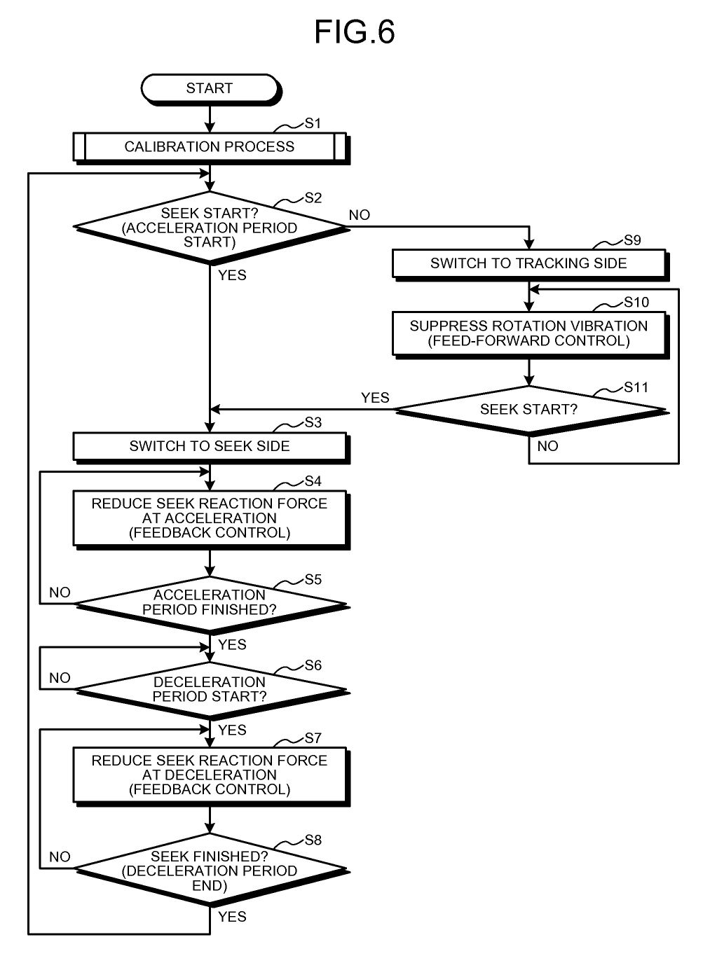

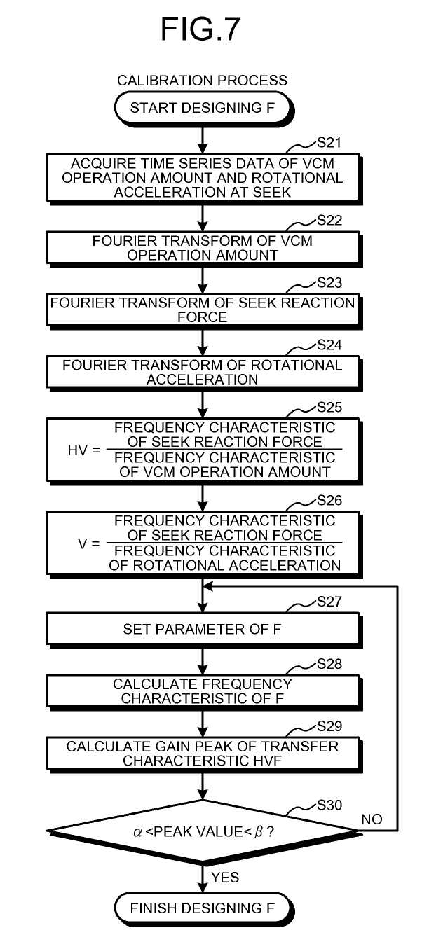

The rotation vibration controller 52 is designed so as to stably operate as a closed loop system (feedback-control system). Hence, a calibration process is performed in the magnetic disk device 100 before going into actual operation. Then the filter characteristic F (a feedback parameter) of the filter 52d is designed taking into account the usage environment for the magnetic disk device 100. Specifically, the magnetic disk device 100 performs operation shown in FIGS. 6 and 7. FIG. 6 is a flow chart showing the operation of the magnetic disk device 100. FIG. 7 is a flow chart showing the calibration process.

After the magnetic disk device 100 is installed in a predetermined environment, the controller 30 performs the calibration process as shown in FIG. 6 (S1). Specifically, as shown in FIG. 7, first, the controller 30 acquires time series data of the VCM operation amount u and of the rotational acceleration signal a′ while having the actuator 4 perform a seek operation for calibration (S21). The controller 30 performs a Fourier-transform on the VCM operation amount u to obtain the frequency characteristic of the VCM operation amount u (S22). Further, the controller 30 subtracts the component indicating the rotation vibration excitation of the casing 1 from the rotational acceleration signal a′ to obtain the component indicating the seek reaction force and performs a Fourier-transform on the component indicating the seek reaction force to obtain the frequency characteristic of the seek reaction force a (S23). The controller 30 acquires beforehand, as the component indicating the rotation vibration excitation of the casing 1, the rotational acceleration signal a′ when the actuator 4 is not performing a seek operation. Further, the controller 30 performs a Fourier-transform on the rotational acceleration signal a′ to obtain the frequency characteristic of the rotational acceleration (S24). The controller 30 obtains the transfer characteristic HV of from the VCM operation amount u to the seek reaction force a from formula 3 below (S25). Further, the controller 30 obtains the transfer characteristic V of from the rotational acceleration signal a′ to the seek reaction force a from formula 4 below (S26). The controller 30 sets a filer coefficient agreeing with the obtained transfer characteristic V in the filter 52c1 (see FIG. 3). That is, the controller 30 measures the transfer characteristic HV of from the VCM operation amount to the reaction force of seek by the actuator 4 (S21 to S26).

HV=(the frequency characteristic of the seek reaction force)/(the frequency characteristic of the VCM operation amount) formula 3

V=(the frequency characteristic of the seek reaction force)/(the frequency characteristic of the rotational acceleration) formula 4

Then the controller 30 changes and sets the filter characteristic F (a feedback parameter) of the filter 52d (S27) and calculates the frequency characteristic F of the filter 52d (S28) and calculates the gain peak value of the open-loop transfer characteristic HVF (S29). The controller 30 repeats the process of changing and setting the feedback parameter of the filter 52d (S27) and calculating the filter frequency characteristic F of the filter 52d (S28) and calculating the gain peak value of the open-loop transfer characteristic HVF (S29) until the gain peak value of the open-loop transfer characteristic HVF comes into the range expressed by the following formula 5 (while No at S30).

α<the peak value<β formula 5

The controller 30 finishes designing the filter characteristic F (a feedback parameter) of the filter 52d if the gain peak value of the open-loop transfer characteristic HVF comes into the range expressed by the formula 5 (Yes at S30). That is, the controller 30 determines the feedback parameter based on results of measuring the transfer characteristic HV (S27 to S30). The controller 30 sets a filer coefficient agreeing with the determined feedback parameter as the filer coefficient for the feedback-control in the filter 52d (see FIG. 3).

Here, α and β are constants satisfying α<β<1. When expressed in units dB, α and β are constants satisfying α<β<0 dB. This design flow is the basics of the design of the filter characteristic F (a feedback parameter) of the filter 52d, and because the transfer characteristic HV varies depending on the way that the casing 1 is fixed or the like, it is appropriate to measure the transfer characteristic HV for the user's usage environment and to redesign the filter characteristic F (a feedback parameter). Further, α and β can be decided on beforehand depending on to what degree the degradation in the performance of the feedback-control is desired to be suppressed.

In FIGS. 4B to 4D, the transfer characteristic HV of from the VCM operation amount u to the seek reaction force a, the transfer characteristic F (a feedback parameter) of the feedback-control, and the open-loop transfer characteristic HVF are shown. Here, the case where α, β are set so that the peak value is about −5 dB is illustrated. With the feedback-control being added, the gain of the transfer characteristic HV is less by, e.g., a maximum of about 5 dB than in the case of not performing feedback-control. In FIGS. 5A and 5B, time series data of the seek reaction force and of the VCM operation amount are shown. As the feedback gain decreases, the effect of reducing the seek reaction force decreases, but there is the effect that the stability against variation in the transfer characteristic HV becomes more robust. If the feedback gain is set at 100%, the seek reaction force can be reduced by, e.g., about 40%, and if the feedback gain is set at 50%, the seek reaction force can be reduced by, e.g., 20%. Note that, if the feedback gain of the filter characteristic F is raised, the VCM operation amount becomes less, resulting in the bad influence of lengthening the seek period and that hence it needs to be balanced with reduction in the seek reaction force.

Referring back to FIG. 6, when the calibration process finishes (S1), the controller 30 determines whether to start a seek operation in normal operation (S2).

For example, when receiving a read request or a write request from a host (not shown), the controller 30 switches the rotation vibration controller 52 to the seek-side configuration (feedback-control configuration) (S3) following the determination that a seek operation is to be started (Yes at S2). Because a seek acceleration period is to be started (Yes at S2), the controller 30 performs the process of reducing the seek reaction force at acceleration (S4).

That is, during the seek acceleration period, the seek reaction force occurs in a rotational direction opposite to that of the seek rotational movement (see FIG. 2D). The controller 30 obtains the seek reaction force a from the rotational acceleration signal a′ detected by the detecting unit 10 and applies the feedback parameter (feedback gain) determined in S27 to S30 to the obtained seek reaction force a to obtain the correction amount Δu2 (<0). The correction amount Δu2 is such a correction amount as to decrease the VCM operation amount u (decrease the absolute value thereof). That is, the controller 30 obtains the correction amount for the VCM operation amount u to make the deviation of the seek reaction force a from the target seek reaction force approach zero. The target seek reaction force may be nearly zero or at a minus-side reaction force value (smaller in absolute value than the peak of the minus-side reaction force shown in FIG. 2D). For example, the controller 30 feedback-controls the actuator 4 so as to reduce the VCM operation amount u, thereby reducing the seek reaction force.

The controller 30 performs the process of reducing the seek reaction force at acceleration (S4) until the seek acceleration period finishes (while No at S5). When the seek acceleration period finishes (Yes at S5), the controller 30 waits until the seek deceleration period starts (while No at S6). When the seek deceleration period starts (Yes at S6), the controller 30 performs the process of reducing the seek reaction force at deceleration (S7).

That is, during the seek deceleration period, the seek reaction force occurs in the same rotational direction as that of the seek rotational movement (see FIG. 2D). The controller 30 obtains the seek reaction force a from the rotational acceleration signal a′ detected by the detecting unit 10 and applies the feedback parameter (feedback gain) determined in S27 to S30 to the obtained seek reaction force a to obtain the correction amount Δu2 (>0). The correction amount Δu2 is such a correction amount as to increase the VCM operation amount u (decrease the absolute value thereof). That is, the controller 30 obtains the correction amount for the VCM operation amount u to make the deviation of the seek reaction force a from the target seek reaction force approach zero. The target seek reaction force may be nearly zero or at a plus-side reaction force value (smaller in absolute value than the peak of the plus-side reaction force shown in FIG. 2D). For example, the controller 30 feedback-controls the actuator 4 so as to increase the VCM operation amount u, thereby reducing the seek reaction force.

When the seek deceleration period finishes (Yes at S8), the controller 30, determining that the seek operation has finished, makes the process return to S2.

In contrast, if not receiving a read request nor a write request from the host (not shown) in a predetermined period, or immediately after a seek operation finishes, the controller 30 determines that a seek operation is not to be started (No at S2). Then the controller 30 switches the rotation vibration controller 52 to the tracking-side configuration (feed-forward control configuration) (S9). The controller 30 performs the process of suppressing the rotation vibration (S10). That is, the controller 30 feed-forward controls the actuator 4 based on the rotation vibration of the casing 1. The controller 30 performs the process of suppressing the rotation vibration (S10) until the timing comes when a seek operation is to be started (while No at S11) and makes the process proceed to S3 when the timing comes at which a seek operation is to be started (Yes at S11).

As described above, in the magnetic disk device 100 according to the first embodiment, the controller 30 feedback-controls the actuator 4 so as to reduce the reaction force acting on the casing 1 during the acceleration period of seek by the actuator 4. For example, the detecting unit 10 detects the rotational acceleration acting on the casing 1 during the seek acceleration period. The controller 30 corrects the VCM operation amount in seek by the actuator 4 so as to reduce the reaction force agreeing with the rotational acceleration detected by the detecting unit 10 during the acceleration period of seek by the actuator 4. For example, the controller 30 feedback-controls the actuator 4 during the seek acceleration period so as to decrease the VCM operation amount u (decrease the absolute value thereof), thereby reducing the seek reaction force. By this means, the vibration of the casing 1 due to the seek reaction force can be suppressed during the seek acceleration period, and where the magnetic disk device 100 and another magnetic disk device are together attached to the housing of a server, the vibration of the other magnetic disk device excited by it can be reduced. As a result, the throughput of the server can be improved during the seek acceleration period of the magnetic disk device 100.

Further, in the first embodiment, in the magnetic disk device 100, the controller 30 feedback-controls the actuator 4 so as to reduce the reaction force acting on the casing 1 during the deceleration period of seek by the actuator 4. For example, the controller 30 feedback-controls the actuator 4 during the seek deceleration period so as to increase the VCM operation amount u (decrease the absolute value thereof), thereby reducing the seek reaction force. By this means, the vibration of the casing 1 due to the seek reaction force can be suppressed during the seek deceleration period, and where the magnetic disk device 100 and another magnetic disk device are together attached to the housing of a server, the vibration of the other magnetic disk device excited by it can be reduced. As a result, the throughput of the server can be improved also during the seek deceleration period of the magnetic disk device 100.

Yet further, in the first embodiment, in the magnetic disk device 100, the controller 30 obtains the correction amount Δu2 for the VCM operation amount u in seek based on the feedback parameter (filter characteristic F) agreeing with the transfer characteristic HV of from the VCM operation amount u to the seek reaction force a of seek by the actuator 4 and the seek reaction force a agreeing with the rotational acceleration a′ detected by the detecting unit 10. For example, the controller 30 measures the transfer characteristic HV of from the VCM operation amount u to the seek reaction force a of seek by the actuator 4 and determines the feedback parameter based on the measuring result. The controller 30 obtains the correction amount Δu2 for the VCM operation amount u in seek based on the determined feedback parameter and the seek reaction force a agreeing with the rotational acceleration a′ detected by the detecting unit 10. Thus, the feedback parameter can be appropriately determined taking into account the usage environment for the magnetic disk device 100, and because the feedback-control is performed with the appropriately determined feedback parameter, the stable feedback-control can be performed. For example, even if the attachment rigidity of the casing 1 changes, so that the characteristic of the seek reaction force varies, by redesigning the feedback parameter (filter characteristic F), stable reduction in the seek reaction force can be achieved.

Still further, in the first embodiment, in the magnetic disk device 100, the controller 30 determines the feedback parameter so that the feedback-control is performed with a feedback gain less than 100% (of, e.g., 50%). Thus, the feedback-control can be stably performed while suppressing the degradation in the performance of the actuator 4.

Further, in the first embodiment, in the magnetic disk device 100, the controller 30 feedback-controls the actuator 4 so as to reduce the reaction force acting on the casing 1 during the seek period and feed-forward controls the actuator 4 based on the rotation vibration of the casing 1 during the tracking period. By this means, the seek reaction force in seek can be reduced, and also the degradation of the accuracy in positioning due to the rotation-vibration-exciting disturbance in tracking can be suppressed.

In the first embodiment, in the magnetic disk device 100, the controller 30 is configured to be able to switch between a feedback-control configuration and a feed-forward control configuration. Thus, the controller 30 can feedback-control the actuator 4 during the seek period and feed-forward control the actuator 4 during the tracking period.

In the first embodiment, in the controller 30 of the magnetic disk device 100, the switching unit 52a enables the feedback unit 52c and the filter 52d during the seek period and enable the feed-forward unit 52b and the filter 52d during the tracking period. Thus, the controller 30 can be switched to the feedback-control configuration during the seek period and to the feed-forward control configuration during the tracking period.

### Second Embodiment

Next, a magnetic disk device 100 according to the second embodiment will be described. Description will be made below focusing on the differences from the first embodiment.

In the second embodiment, tactics to approximately obtain the transfer characteristic HV of from the VCM operation amount u to the seek reaction force a are implemented in order to simplify the calibration process.

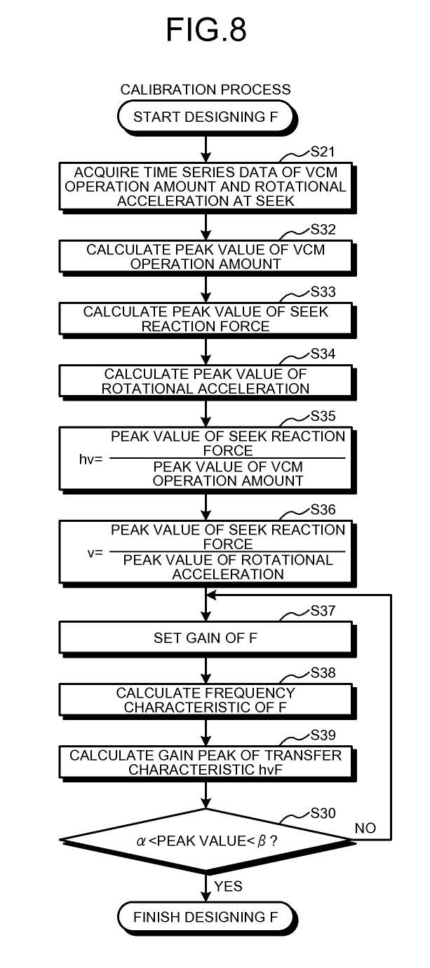

Specifically, in the calibration process (S1) shown in FIG. 6, instead of steps S22 to S29 shown in FIG. 7, steps S32 to S39 shown in FIG. 8 are executed. That is, time series data of the VCM operation amount u and of the rotational acceleration signal a′ are acquired (S21), and the controller 30 obtains the peak value of the VCM operation amount u (S32). The controller 30 subtracts the component indicating the rotation vibration excitation of the casing 1 from the rotational acceleration signal a′ to obtain the component indicating the seek reaction force and to obtain the peak value of the seek reaction force a (S33). The controller 30 acquires beforehand, as the component indicating the rotation vibration excitation of the casing 1, the rotational acceleration signal a′ when the actuator 4 is not performing a seek operation. Further, the controller 30 obtains the peak value of the rotational acceleration (rotational acceleration signal a′) (S34). The controller 30 approximately obtains the transfer characteristic hv of from the VCM operation amount u to the seek reaction force a from formula 6 below (S35). Further, the controller 30 approximately obtains the transfer characteristic v of from the rotational acceleration signal a′ to the seek reaction force a from formula 7 below (S36). The controller 30 sets a filer coefficient agreeing with the obtained transfer characteristic v in the filter 52c1 (see FIG. 3). That is, the controller 30 measures the peak value of the VCM operation amount and the peak value of the seek reaction force in seek by the actuator 4 to approximately obtain the transfer characteristic hv from the ratio between the two (S21 to S36).

HV≈hv=(the peak value of the seek reaction force)/(the peak value of the VCM operation amount) formula 6

V≈v=(the peak value of the seek reaction force)/(the peak value of the rotational acceleration) formula 7

Then the controller 30 changes and sets the gain of the filter characteristic F (a feedback parameter) of the filter 52d (S37) and calculates the frequency characteristic F of the filter 52d (S38) and calculates the gain peak value of the open-loop transfer characteristic hvF (S39). The controller 30 repeats the process of changing and setting the gain of the feedback parameter of the filter 52d (S37) and calculating the frequency characteristic F of the filter 52d (S38) and calculating the gain peak value of the open-loop transfer characteristic hvF (S39) until the gain peak value of the open-loop transfer characteristic hvF comes into the range expressed by the formula 5 (while No at S30).

The controller 30 finishes designing the filter characteristic F (a feedback parameter) of the filter 52d if the gain peak value of the open-loop transfer characteristic hvF comes into the range expressed by the formula 5 (Yes at S30). That is, the controller 30 determines the feedback parameter based on results of measuring the peak value of the VCM operation amount and the peak value of the seek reaction force in seek (S37 to S30). The controller 30 sets a filer coefficient agreeing with the determined feedback parameter as the filer coefficient for the feedback-control in the filter 52d (see FIG. 3).

As described above, in the second embodiment, in the magnetic disk device 100, the controller 30 measures each of the peak value of the VCM operation amount and the peak value of the reaction force in seek by the actuator 4 to approximately obtain the transfer characteristic hv of from the VCM operation amount u to the seek reaction force a based on the measuring results. The controller 30 determines the feedback parameter using the approximately obtained transfer characteristic hv. Therefore, the amount of calculation by the controller 30 for obtaining the transfer characteristic hv of from the VCM operation amount u to the seek reaction force a can be reduced, and thus the calibration process can be simplified. As a result, in the magnetic disk device 100, the time required for the calibration process can be shortened.

It should be noted that, the calibration process (s1) may be further simplified. For example, the controller 30 predicts the maximum gain of the transfer characteristic HV beforehand and determines the feedback parameter based on the predicting result. That is, the controller 30 designs the filter characteristic F (a feedback parameter) to be robust such that, even with the transfer characteristic HV having the predicted maximum gain, the closed-loop characteristic (open-loop transfer characteristic HVF) is stable. For example, because the maximum gain of the transfer characteristic V corresponds to the state where the casing 1 has no support, steps S21 to S26 shown in FIG. 7 are executed in that state to predict the transfer characteristic HV. Steps S27 to S30 shown in FIG. 7 are executed using the predicted transfer characteristic HV to design the filter characteristic F (a feedback parameter). By this means, a feedback-control system which can deal with the assumed cases of the seek reaction force characteristic can be realized.

### Third Embodiment

Next, a magnetic disk device 300 according to the third embodiment will be described. Description will be made below focusing on the differences from the first embodiment.

In the third embodiment, the configuration to switch between the feedback-control and the feed-forward control is different from that of the first embodiment.

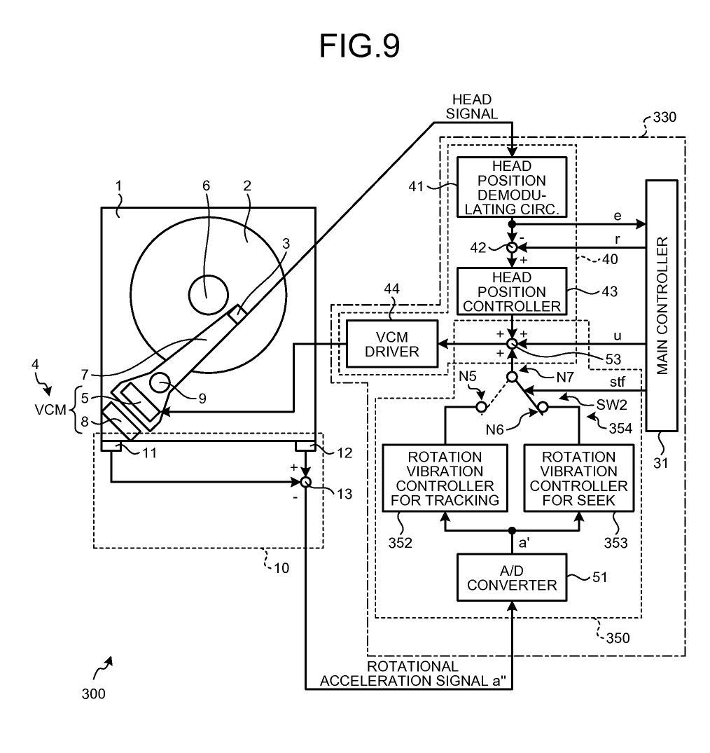

Specifically, as shown in FIG. 9, the controller 330 of the magnetic disk device 300 has a correcting unit 350 instead of the correcting unit 50 (see FIG. 1). FIG. 9 is a block diagram showing the configuration of the magnetic disk device 300. The correcting unit 350 has a rotation vibration controller 352 for tracking, a rotation vibration controller 353 for seek, and a switching unit 354 instead of the rotation vibration controller 52 (see FIG. 1).

During the seek period, the switching unit 354 enables the rotation vibration controller 353 for seek while disabling the rotation vibration controller 352 for tracking. During the tracking period, the switching unit 354 enables the rotation vibration controller 352 for tracking while disabling the rotation vibration controller 353 for seek. Thus, the switching unit 354 switches the configuration of the correcting unit 350 to the feedback-control configuration during the seek period and to the feed-forward control configuration during the tracking period.

For example, the switch unit 354 has nodes N5 to N7 and a switch SW2. The node N5 is connected to the output side of the rotation vibration controller 352 for tracking. The node N6 is connected to the output side of the rotation vibration controller 353 for seek. The node N7 is connected to the adder 53. The switch SW2 switches between the state of the node N6 being connected to the node N7 (the state indicated by a solid line in FIG. 9) and the state of the node N5 being connected to the node N7 (the state indicated by a broken line in FIG. 9) according to the value of the determination flag stf.

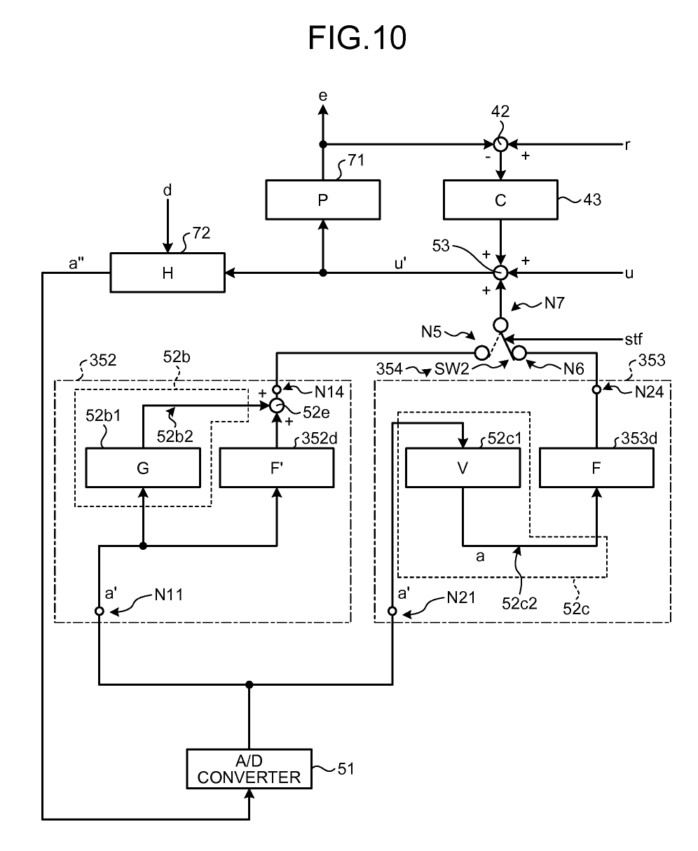

Next, the configuration of the rotation vibration controller 353 for seek and rotation vibration controller 352 for tracking will be described with reference to FIG. 10. FIG. 10 is a diagram showing the configuration of the rotation vibration controller 353 for seek and rotation vibration controller 352 for tracking. The rotation vibration controller 352 for tracking has the configuration where the feedback unit 52c and the switching unit 52a are omitted from the rotation vibration controller 52 (see FIG. 3) and where the filter 52d is replaced with the filter 352d as shown in FIG. 10. The filter 352d can be a filter for the feed-forward control. For example, the filter 352d has a filter coefficient (filter characteristic F′) for the feed-forward control and does not have a filter coefficient (filter characteristic F) for the feedback-control.

The rotation vibration controller 353 for seek has the configuration where the feed-forward unit 52b and the switching unit 52a are omitted from the rotation vibration controller 52 (see FIG. 3) and where the filter 52d is replaced with the filter 353d as shown in FIG. 10. The filter 353d can be a filter for the feedback-control. For example, the filter 353d has a filter coefficient (filter characteristic F) for the feedback-control and does not have a filter coefficient (filter characteristic F′) for the feed-forward control.

If the determination flag stf is at a value indicating the tracking period (e.g., 0), the switch SW2 of the switch unit 354 switches the node N5 to the state of being connected to the node N7. Thus, during the tracking period, each of the path from the node N11 via the filter 352d to the node N14 and the path from the node N11 via the feed-forward unit 52b to the node N14 can be enabled. That is, the correcting unit 350 can be switched to the feed-forward control configuration.

If the determination flag stf is at a value indicating the seek period (e.g., 1), the switch SW2 switches the node N6 to the state of being connected to the node N7. Thus, during the seek period, the path from the node N21 via the feedback unit 52c and the filter 353d to the node N24 can be enabled. That is, the correcting unit 350 can be switched to the feedback-control configuration.

As described above, in the third embodiment, in the controller 330 of the magnetic disk device 300, the switching unit 354 enables the rotation vibration controller 353 for seek during the seek period and enables the rotation vibration controller 352 for tracking during the tracking period. Thus, the controller 330 can be switched to the feedback-control configuration during the seek period and to the feed-forward control configuration during the tracking period.

Next, a storage device 500 in which a magnetic disk device according to the first to the third embodiment is used will be described. The case where the magnetic disk devices 100-1, 110-2 according to the first embodiment are used in plurality in the storage device 500 will be described illustratively below.

The storage device 500 is, for example, a server and has a housing and a plurality of magnetic disk devices 100-1, 110-2. The casings 1-1, 1-2 of the plurality of magnetic disk devices 100-1, 110-2 are housed in the housing and fixed to an inner wall surface of the housing.

The storage device 500 can be a blade server whose housing is formed thin like a blade so as to be able to be easily inserted into and pulled out of, e.g., a server computer. Because blade servers are required to be compact and light, their housings are made thinner and lighter. Hence, the rigidity of the housing may be low. In this case, vibration of the casing 1-1 associated with the seek reaction force from the magnetic disk device 100-1 is likely to be transmitted to the casing 1-2 of the other magnetic disk device 100-2 via the housing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a casing;
a seek mechanism attached to the casing and configured to make a magnetic head seek a target track on a magnetic disk; and
a controller configured to feedback-control the seek mechanism so as to reduce a reaction force acting on the casing during an acceleration period of seek by the seek mechanism.

2. The magnetic disk device of claim 1, wherein
the controller feedback-controls the seek mechanism so as to reduce a reaction force acting on the casing further during a deceleration period of seek by the seek mechanism.

3. The magnetic disk device of claim 1, further comprising a detecting unit configured to detect rotational acceleration acting on the casing,
wherein the controller corrects an operation amount of seek by the seek mechanism so as to reduce a reaction force corresponding to the detected rotational acceleration during the acceleration period of seek by the seek mechanism.

4. The magnetic disk device of claim 3, wherein the detecting unit has:
a plurality of acceleration sensors configured to detect acceleration acting on the casing respectively; and
a difference unit that obtains a difference between the accelerations detected by the plurality of acceleration sensors as rotational acceleration.

5. The magnetic disk device of claim 3, wherein
the controller obtains the correction amount based on a feedback parameter corresponding to a transfer characteristic from the seek operation amount to the reaction force acting on the casing, and on the reaction force acting on the casing.

6. The magnetic disk device of claim 5, wherein
the controller determines the feedback parameter such that feedback-control is performed with a feedback gain less than 100% of the deviation with respect to a deviation of the reaction force acting on the casing from a target reaction force.

7. The magnetic disk device of claim 3, wherein
the controller measures each of a peak value of the operation amount of seek by the seek mechanism and a peak value of the reaction force acting on the casing, determines a feedback parameter based on the measured results, and obtains a correction amount based on the determined feedback parameter and the reaction force acting on the casing.

8. The magnetic disk device of claim 7, wherein
the controller determines the feedback parameter such that feedback-control is performed with a feedback gain less than 100% of the deviation with respect to a deviation of the reaction force acting on the casing from a target reaction force.

9. The magnetic disk device of claim 3, wherein
the controller predicts a maximum gain of a transfer characteristic from the operation amount of seek by the seek mechanism to the reaction force acting on the casing, determines a feedback parameter based on the predicting result, and obtains a correction amount for the seek operation amount based on the determined feedback parameter and the reaction force acting on the casing.

10. The magnetic disk device of claim 9, wherein
the controller determines the feedback parameter such that feedback-control is performed with a feedback gain less than 100% of a deviation with respect to a deviation of the reaction force acting on the casing from a target reaction force.

11. The magnetic disk device of claim 1, wherein
the controller further feed-forward controls the seek mechanism based on rotation vibration of the casing during a tracking period.

12. The magnetic disk device of claim 11, wherein
the controller is configured to be able to switch between the feedback-control and the feed-forward control.

13. The magnetic disk device of claim 12, further comprising a detecting unit that detects rotational acceleration acting on the casing,
wherein the controller further comprises:
a filter;
a feedback unit that obtains a reaction force corresponding to the rotational acceleration detected by the detecting unit to supply to an input side of the filter;
a feed-forward unit that obtains a correction amount corresponding to the rotational acceleration detected by the detecting unit to supply to an output side of the filter; and
a switching unit that enables the feedback unit and the filter during the seek period and enables the feed-forward unit and the filter during the tracking period.

14. The magnetic disk device of claim 12, wherein the controller further comprises:
a first controller that feedback-controls the seek mechanism so as to reduce a reaction force acting on the casing;
a second controller that feed-forward controls the seek mechanism based on the rotation vibration of the casing; and
a switching unit that enables the first controller during the seek period and enables the second controller during the tracking period.

15. The magnetic disk device of claim 14, wherein the controller further comprises a detecting unit that detects rotational acceleration acting on the casing,
wherein the first controller further comprises:
a first filter; and
a feedback unit that obtains a reaction force corresponding to the rotational acceleration detected by the detecting unit to supply to an input side of the first filter, and
wherein the second controller further comprises:
a second filter; and
a feed-forward unit that obtains a correction amount corresponding to the rotational acceleration detected by the detecting unit to supply to an output side of the second filter.

16. A control method for a magnetic disk device having a casing and a seek mechanism attached to the casing that makes a magnetic head seek a target track on a magnetic disk, the control method comprising:
feedback-controlling the seek mechanism so as to reduce a reaction force acting on the casing during an acceleration period of seek by the seek mechanism.

17. The control method of claim 16, further comprising: feedback-controlling the seek mechanism so as to reduce a reaction force acting on the casing during a deceleration period of seek by the seek mechanism.

18. The control method of claim 16, wherein
the feedback-controlling comprises:
detecting rotational acceleration acting on the casing; and
correcting an operation amount of seek by the seek mechanism so as to reduce a reaction force agreeing with the detected rotational acceleration.

19. The control method of claim 18, wherein
the correcting the operation amount of seek comprises obtaining the correction amount based on a feedback parameter corresponding to a transfer characteristic from the seek operation amount to the reaction force acting on the casing, and on the reaction force acting on the casing.

20. The control method of claim 19, wherein
the correcting the operation amount of seek comprises obtaining the correction amount using feedback parameter determined such that feedback-control is performed with a feedback gain less than 100% of a deviation with respect to a deviation of the reaction force acting on the casing from a target reaction force.
